(19) United States
(12) Patent Application Publication
(10) Pub. No.: US 2018/0023683 A1
(43) Pub. Date: Jan. 25, 2018

(54) SYSTEM AND METHOD FOR MANAGING TRANSMISSION FLUID TEMPERATURE

(71) Applicant: GM GLOBAL TECHNOLOGY OPERATIONS LLC, DETROIT, MI (US)

(72) Inventors: Jeffrey R. Kelly, Whittaker, MI (US); Addison T. Solak, Macomb, MI (US); John W. Myers, Howell, MI (US); Jeffrey M. Pleune, Rochester Hills, MI (US)

(21) Appl. No.: 15/213,983

(22) Filed: Jul. 19, 2016

(51) Int. Cl. F16H 57/04; F28D 1/03; F28F 27/02; F28F 9/22; F28F 19/01; F28D 1/02; F28D 1/04

(52) U.S. Cl. CPC F16H 57/0417; F16H 57/0423; F16H 57/0404; F28D 1/0213; F28D 1/0341; F28D 1/04; F28F 9/22; F28F 19/01; F28F 27/02; F28D 2021/0089

(57) ABSTRACT

A system and method for managing transmission temperature includes a transmission housing enclosing transmission components for transmitting kinetic energy and transmission fluid, and a heat exchanger within the transmission housing.

### FIELD

The present disclosure relates to a system and method for managing transmission fluid temperature.

### INTRODUCTION

The introduction provided herein is for the purpose of generally presenting the context of the disclosure. Work of the presently named inventors, to the extent it is described in this introduction section, as well as aspects of the description that may not otherwise qualify as prior art at the time of filing, are neither expressly nor impliedly admitted as prior art against the present disclosure.

Modern motor vehicle transmissions use several quarts or liters of transmission fluid or hydraulic oil. The transmission fluid serves several purposes. First the fluid lubricates the numerous moving and rotating parts within the transmission. Second the fluid serves as a heat transfer mechanism to maintain an appropriate operating temperature and third is the use in a hydraulic control system for the transmission.

Attempts at maintaining transmission fluid temperatures within an acceptable operating range have relied upon a transmission oil cooler or warmer remotely located from the transmission which acts to dissipate or absorb heat. A portion of the flow of transmission fluid in the transmission is diverted from the operational flow within the transmission to the external cooler/warmer.

During cold weather starts, the cold transmission fluid can have a high viscosity which can significantly reduce the operating efficiency of the transmission, such as, for example, parasitic frictional losses or resistance to pumping. Depending upon the ambient temperature, it can take a significant amount of time before the transmission fluid temperature rises into a range where operational efficiency is improved to a satisfactory level. This delay is primarily due to the fact that frictional heating from the components within the transmission itself is the only source of heat for raising the transmission fluid temperature. During this time, operational efficiency can be significantly reduced, resulting in, for example, degraded fuel economy.

It is therefore apparent that improved control of the temperature of transmission fluid is desirable.

### SUMMARY

A system for managing transmission fluid temperature includes a transmission housing enclosing transmission components for transmitting kinetic energy and transmission fluid, and a heat exchanger within the transmission housing. A method for managing transmission fluid temperature includes providing a transmission housing enclosing transmission components for transmitting kinetic energy and transmission fluid, and providing a heat exchanger within the transmission housing. In this manner, the heat exchanger may be placed within the operational flow path of the fluid, rather than merely in a diversionary flow path in which only a portion of the fluid flow may be exposed to a heat exchanger. In this manner a much larger portion of the flow of transmission fluid, if not the entire flow, in the transmission housing can be exposed to the heat exchanger. This greatly improves the capacity for heat transfer by the heat exchanger, which improves the rate at which heat may be transferred into or from the transmission fluid. For example, the presence of the heat exchanger within the transmission enables the transmission fluid to be heated much more quickly during cold startup conditions which can greatly increase the efficiency and operational effectiveness of the transmission during the cold startup conditions. Similarly, the greater capacity to transfer heat from the transmission provides for a much more effective system of transferring heat away from the transmission to maintain the temperature of the fluid within a preferred range of operating temperatures.

The present invention is in stark contrast to systems which may provide a transmission fluid heat exchanger external to the transmission housing and, therefore, can only send a portion of the flow of transmission fluid to the external heat exchanger, which limits the heat transfer capability of the heat exchanger and the rate at which heat may be exchanged. For example, an externally mounted heat exchanger may only receive about one third of the volume of fluid that flows through the transmission. Further, positioning the heat exchanger outside of the transmission housing requires that a portion of the normal, operational flow of fluid be shunted off a new or different path that is not otherwise necessary to the operation of the transmission. Mounting the heat exchanger within the transmission housing enables positioning of that heat exchanger directly in the path of the normal flow of fluid through the transmission that would have occurred even in the absence of a heat exchanger. This further provides the opportunity to optimize the configuration of the heat exchanger to minimize and/or avoid any disruption in the flow of transmission fluid through the transmission.

Additionally, positioning the heat exchanger outside of the transmission requires the addition of fluid communication channels between the transmission and the remotely mounted heat exchanger. This increase in the path for the transmission fluid requires additional energy to cause the fluid to flow through this additional path. In some instances, this may even require not only additional valving, but may also require a secondary pumping system to force that portion of fluid through this additional path. All of these factors increase the amount of energy required to take advantage of the remotely mounted heat exchanger and reduce the efficiency of the transmission. Mounting the heat exchanger within the transmission housing in accordance with an exemplary embodiment of the present invention obviates the necessity of these structures and, therefore, significantly increases the overall efficiency of the transmission.

Further areas of applicability of the present disclosure will become apparent from the detailed description provided hereinafter. It should be understood that the detailed description and specific examples are intended for purposes of illustration only and are not intended to limit the scope of the disclosure.

The above features and advantages, and other features and advantages, of the present invention are readily apparent from the detailed description, including the claims, and exemplary embodiments when taken in connection with the accompanying drawings.

### BRIEF DESCRIPTION OF THE DRAWINGS

The present disclosure will become more fully understood from the detailed description and the accompanying drawings, wherein:

FIG. 1 is a schematic illustration of a propulsion system 100 in accordance with an exemplary embodiment;

FIG. 2 is a cross-sectional perspective view of a sump 200 of a transmission 202 in accordance with an exemplary embodiment;

FIG. 3A is a perspective view of the heat exchanger 214 from FIG. 2;

FIG. 3B is a cross-sectional perspective view of the heat exchanger from FIGS. 2 and 3A;

FIG. 4 illustrates a sump area 400 in a transmission in accordance with an exemplary embodiment;

FIG. 5A is a perspective view of another heat exchanger 500; and

FIG. 5B is a cross sectional perspective view of the heat exchanger 500.

### DETAILED DESCRIPTION

The enclosed description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

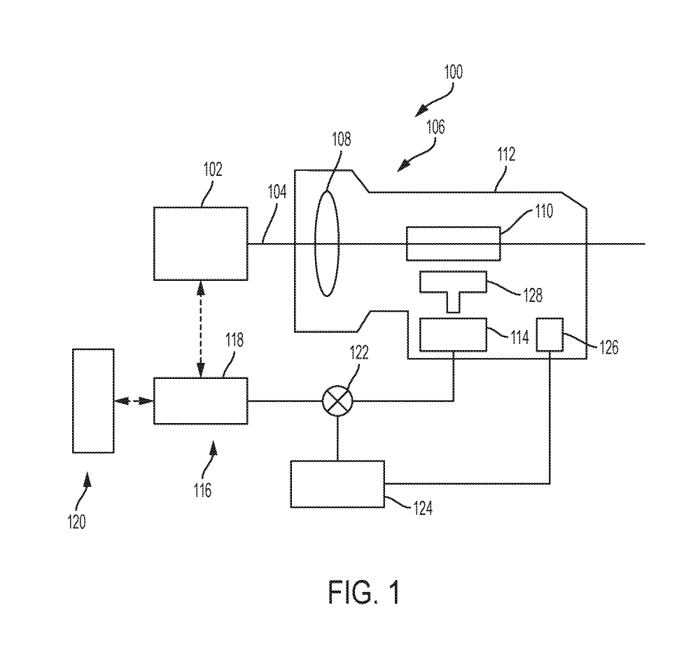

FIG. 1 is a schematic illustration of a propulsion system 100 in accordance with an exemplary embodiment. The propulsion system 100 includes an engine 102 providing kinetic energy via a coupling 104 to a transmission 106. The transmission 106 may be connected to the coupling 104 via a torque converter 108. The torque converter 108 in turn is coupled to a plurality of kinetic energy transmitting devices 110. The kinetic energy transmitting devices 110 may be, for example, friction clutches and brakes arranged with planetary gear sets or the like. The transmission 106 includes a housing 112 that encloses the components of the transmission 106 along with transmission fluid or transmission oil that lubricates and cools/warms the components within the transmission 106. In an automatic transmission, the transmission fluid may also be used to operate clutches to selectively engage gear sets in a hydraulic control system (not shown).

In accordance with an exemplary embodiment, the transmission housing 112 also encloses a heat exchanger 114. The heat exchanger 114 is positioned within the transmission housing 112 to enable heat transfer to and/or from the transmission fluid enclosed within the transmission housing 112. The heat exchanger 114 may be in fluid communication using fluid heat transfer medium capable of circulating within the heat exchanger 114 and of flowing to and from the heat exchanger 114 via passages extending through walls of the transmission housing 112 to a thermal management system 116 located external to the transmission 106. For example, a thermal management system 116 may be positioned external to the transmission 106 and serve to distribute and manage the transfer of heat between multiple components within an automobile.

The thermal management system 116 in FIG. 1 includes a heat exchanger 118 which may be associated with the engine 102 and/or another thermally active device such as, for example, a radiator 120. The thermal management system 116 may include any number of heat exchangers which may exchange heat with, for example, the radiator 120, an engine block within the engine 102, an exhaust manifold, exhaust system of the engine, power steering systems, and/or the like. The present invention is not limited to any specific structure of a thermal management system, other than that the system be capable of circulating a heat exchanging medium through the heat exchanger 114 within the transmission 106.

The heat exchanger 118 may be in selective fluid communication with the heat exchanger 114. The flow of fluid to the heat exchanger 114 being controlled via a fluid switching system, an example of which is schematically illustrated as a valve 122. Another example of a fluid switching system may include a thermostat The thermal management system 116 further may include a controller 124 that controls the flow of fluid to the heat exchanger 114 based upon, for example, a signal received from a temperature sensor 126 positioned within the transmission housing 112. In this manner, the controller 124 can selectively switch the flow of fluid to the heat exchanger 114 to, for example, provide heat to the heat exchanger 114 to increase the temperature of the transmission fluid as may be desirable in a cold start condition, or the controller 124 may selectively switch the flow of fluid to the heat exchanger 114 to, for example, remove heat from the heat exchanger 114 to maintain the temperature of the transmission fluid within a desired range of temperatures.

In the exemplary transmission 106 schematically illustrated in FIG. 1, a pump/filter 128 may also be located within the transmission housing 112. The pump/filter 128 motivates the transmission fluid to circulate within the transmission housing 112 to provide lubrication, heat management, and/or for use within a hydraulic control system to selectively engage clutches and/or gear sets within the transmission in an automatic transmission. In the exemplary embodiment of FIG. 1, the heat exchanger 114 is positioned near and/or adjacent to an inlet to the pump/filter 128 such that a substantial majority of the flow of transmission fluid being circulated through the transmission contacts heat exchanging surface of the heat exchanger 114. In this manner, the efficiency of heat transfer between the heat exchanger 114 and the transmission fluid is maximized, which, thereby, increases the heat transfer capacity and may significantly reduce the amount of time it takes to change the temperature of the transmission fluid to within a desired operating range of temperatures. Additionally, the configuration of the heat exchanger 114 may be adapted to optimize or maximize the contact of the transmission fluid to the heat exchanger 114 before it enters the inlet of the pump/filter 128 as will be explained in accordance with exemplary heat exchangers below.

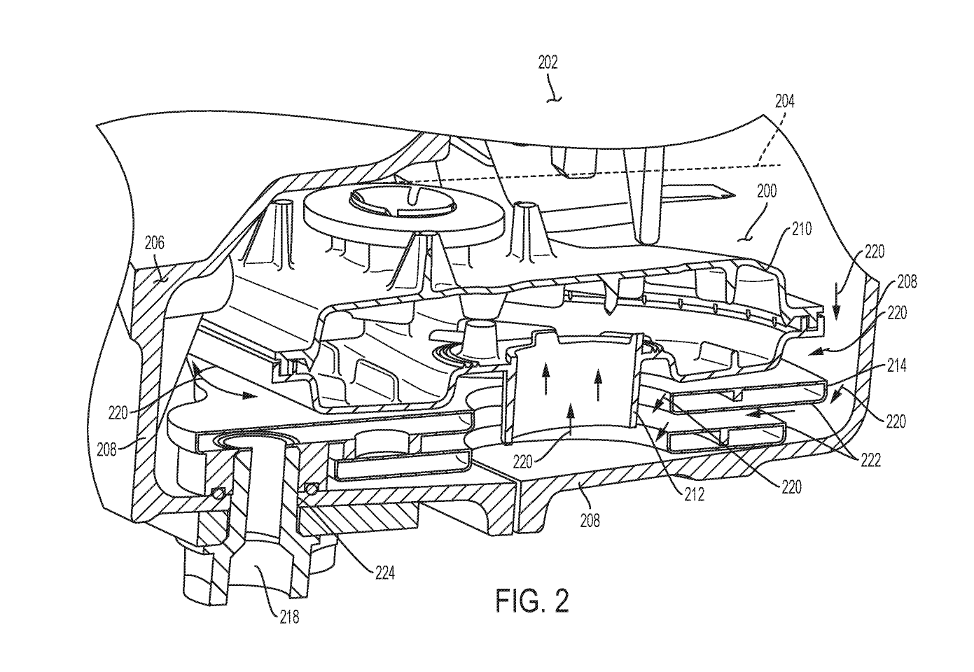

FIG. 2 shows a cross-sectional perspective view of a sump 200 of an exemplary transmission 202. The sump 200 is typically filled with transmission fluid (not illustrated) to a level 204 such that the components located within the sump 200 are immersed in the transmission fluid. The transmission 202 includes a transmission housing 206 having walls 208 defining the outer extent of the transmission housing 206 and which enclose the components within the housing 206 and maintain the transmission fluid within the housing 206. A transmission fluid filter 210 is positioned within the sump 200 of the transmission 202. The transmission fluid filter 210 includes an inlet 212 that receives transmission fluid from the sump 200. The filter 210 may form a portion of a pump or may be in fluid communication with a pump (not shown) which motivates the fluid to flow into the inlet 212 and through the filter 210. In another exemplary embodiment, the transmission sump 200 may not include a filter 210, but may only include a pump (not shown). In any case, transmission fluid is drawn from the sump 200 for use elsewhere in the transmission.

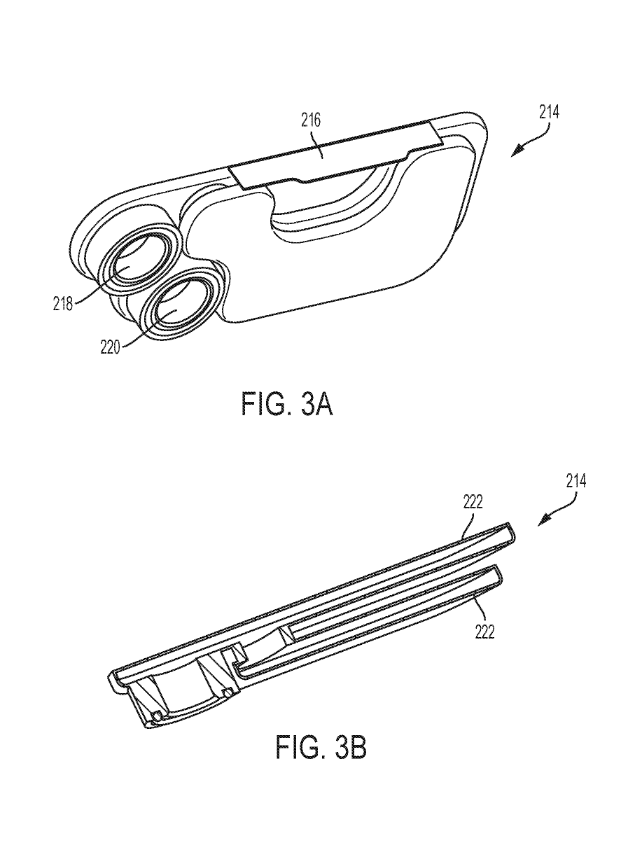

A heat exchanger 214 is also positioned within the sump 200 of the transmission housing 206. The heat exchanger 214 is configured to optimize the exposure of the transmission fluid being drawn from the sump 200 and into the inlet 212 to the heat exchanging surfaces of the heat exchanger 214. For example, as may be more easily understood with reference to FIGS. 3A and 3B, the heat exchanger 214 may form a u-shape in order to substantially surround the inlet 212 such that substantially the entire flow (see flow lines 220) of transmission fluid from the sump 200 into the inlet 212 contacts heat exchanging surfaces of the heat exchanger 214, thereby maximizing the capacity of the heat exchanger 214 to transfer heat to and/or from the transmission fluid.

As illustrated in FIGS. 3A and 3B, the heat exchanger 214 is a configuration that includes a stacked set of crescent-shaped plates 222. The plates 222 are hollow to provide flow of heat transfer fluid media within the plates 222. The surface of the plates 222 may include surface features (not shown) such as dimples, guides, or ridges to affect the flow of the fluid across the heat transfer surfaces and/or to improve or maximize the surface area or heat transfer characteristics of the interaction between the transmission fluid and the heat transfer surfaces of the heat exchanger 214 to improve the capacity of heat transfer between the transmission fluid and the heat exchanger 214. The surface features may also be designed to minimize the pressure drop of the flow across the heat exchanging surfaces and/or to improve heat transfer characteristics between the oil and heat exchanging surfaces.

The heat exchanger 214 includes a baffle 216 which may serve to guide the flow of transmission fluid from the sump 200 into contact with heat exchanging surfaces of the heat exchanger 214. Alternatively, the baffle 216 may be configured to prevent or block the flow of transmission fluid from the sump 200 to the inlet 212 via a flow path that might not otherwise come into contact with the heat exchanging surfaces of the heat exchanger 214. Such a baffle 216 may be useful in those instances where there may be insufficient space to provide heat exchanging surface of the heat exchanger 214 such as where, for example, the inlet 212 may be positioned very close a wall 208 of the transmission housing 206.

The heat exchanger 214 includes an inlet passage 218 and an outlet passage 220 which extend through corresponding passages 224 in the walls 208 of the transmission housing 206. In this manner, the heat exchanger 214 may be in fluid communication with the outside of the transmission to enable flow of a fluid heat transfer media provided and/or controlled by, for example, an exemplary thermal management system 116.

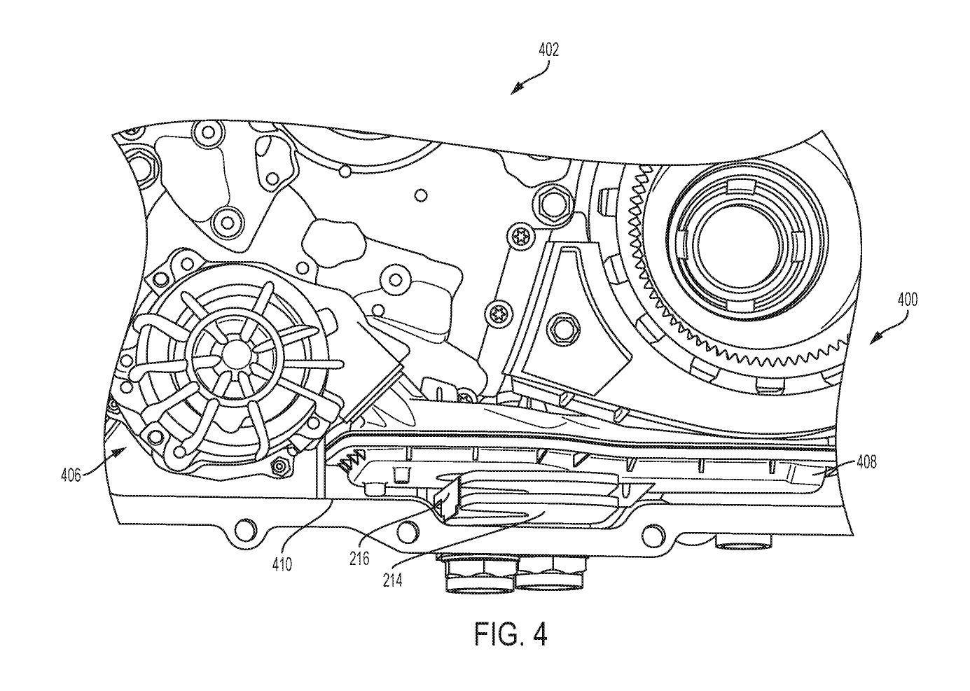

FIG. 4 illustrates another exemplary sump area 400 in a transmission 402. The transmission sump area 400 includes a pump 406, a filter 408 and the heat exchanger 214. The inlet to the filter 408 is close to a wall 410 of the transmission housing sump area 400. Therefore, there is not enough space to position heat transfer surfaces of the heat exchanger between the inlet and the wall 410. In this instance, the baffle 216 serves block the flow of the fluid from the sump 400 into the inlet where heat exchanging surfaces of the heat exchanger are not located. Rather, the baffle 216 redirects the flow of fluid into the inlet such that the fluid contact heat exchanging surfaces of the heat exchanger 214 before entering the inlet.

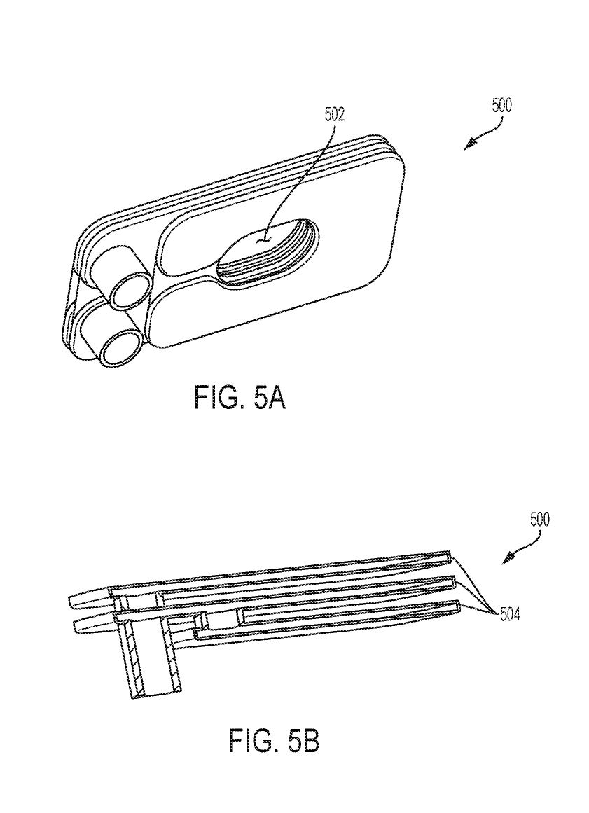

FIGS. 5A and 5B illustrate another exemplary embodiment of a heat exchanger 500 that includes a central opening 502 that is surrounded by heat exchanging surfaces of annular-shaped plates 504. This heat exchanger 500 may be positioned within a transmission housing such that the central opening 502 receives a fluid inlet. In this manner, the heat exchanging surfaces of the annular-shaped plates 504 substantially surround the central opening 502 which requires the flow of fluid into an inlet positioned in the central opening to contact the heat exchanging surfaces of the annular-shaped plates 504. Other alternative embodiments of a heat exchanger may be adapted to the environment and/or structures within the housing to provide for heat transfer to and/or from the transmission fluid and remain within the scope of the present invention. For example, a heat exchanger may be configured as a tube assembly or any other structure.

The heat exchanger may be positioned anywhere within the transmission housing so long as at least some heat transfer enabling contact is provided between the heat exchanger and the transmission fluid within the transmission housing. For example, the heat exchanger may be positioned in an area within the transmission housing where transmission fluid may be splashed onto the heat exchanger or the heat exchanger may sit in its own sump area (not shown) to accommodate other considerations such as packaging and/or space limitations.

What is claimed is:

1. A system for managing transmission fluid temperature comprising:
a transmission housing enclosing transmission components for transmitting kinetic energy and transmission fluid; and
a heat exchanger within the transmission housing.

2. The system of claim 1, further comprising an inlet of one of a pump within the transmission housing and a filter within the transmission housing, wherein the heat exchanger is positioned adjacent to the inlet.

3. The system of claim 2, wherein the pump circulates the transmission fluid within the transmission housing.

4. The system of claim 2, wherein heat exchanging surfaces of the heat exchanger substantially surround the inlet such that substantially all of the flow of the transmission fluid contacts the heat exchanging surfaces before entering the inlet.

5. The system of claim 2, wherein the heat exchanger comprises a stacked set of plates.

6. The system of claim 2, wherein the heat exchanger is configured to contact a substantial majority of a flow of transmission fluid into the inlet.

7. The system of claim 1, wherein the heat exchanger is positioned within a transmission fluid sump within the transmission housing.

8. The system of claim 1, further comprising baffling to direct a flow of transmission fluid across a heat exchanging surface of the heat exchanger.

9. The system of claim 8, wherein the baffling is on the heat exchanging surface of the heat exchanger.

10. The system of claim 1, wherein the heat exchanger comprises a tube assembly heat exchanger.

11. A method for managing transmission fluid temperature comprising:
providing a transmission housing enclosing transmission components for transmitting kinetic energy and transmission fluid; and
providing a heat exchanger within the transmission housing.

12. The method of claim 11, further comprising providing an inlet of one of a pump within the transmission housing and a filter within the transmission housing, wherein the heat exchanger is positioned adjacent to the inlet.

13. The method of claim 12, wherein the pump circulates the transmission fluid within the transmission housing.

14. The method of claim 12, heat exchanging surfaces of the heat exchanger substantially surround the inlet such that substantially all of the flow of the transmission fluid contacts the heat exchanging surfaces before entering the inlet.

15. The method of claim 12, wherein the heat exchanger comprises a stacked set of plates.

16. The method of claim 12, wherein the heat exchanger is configured to contact a substantial majority of a flow of transmission fluid into the inlet.

17. The method of claim 11, wherein the heat exchanger is positioned within a transmission fluid sump within the transmission housing.

18. The method of claim 11, further comprising providing baffling to direct a flow of transmission fluid across a heat exchanging surface of the heat exchanger.

19. The method of claim 18, wherein the baffling is on the heat exchanging surface of the heat exchanger.

20. The method of claim 11, wherein the heat exchanger comprises a tube assembly heat exchanger.
